(19) United States
(12) Patent Application Publication
(10) Pub. No.: US 2015/0013079 A1
(43) Pub. Date: Jan. 15, 2015

(54) Webbing System Incorporating One or More Novel Safety Features

(71) Applicant: Robert E Golz, Swansea, MA (US)

(72) Inventor: Robert E Golz, Swansea, MA (US)

(21) Appl. No.: 14/280,890

(22) Filed: May 19, 2014

Related U.S. Application Data
(60) Provisional application No. 61/824,724, filed on May 17, 2013.

(51) Int. Cl. A62B 35/00; D06P 3/82; D06P 1/00; D03D 15/00; D03D 1/00

(52) U.S. Cl. CPC A62B 35/0075; D03D 15/0033; D03D 1/0041; D06P 1/0096; D06P 1/004; D06P 3/82; D10B 2331/04
USPC 8/638

(57) ABSTRACT

In general, the present invention has to do with an improved webbing system incorporating one or more novel safety features such as webbing or yarns dyed with UV reactive dyes and incorporating a UV reference indicator. The UV reference indicator is calibrated to represent the color or shade of the UV reactive dye after a predetermined exposure time to a UV radiation source.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:
1. U.S. provisional patent application 61/824,724, entitled “A Webbing System Incorporating a UV Reactive Dye and Corresponding UV Reference Indicator”, naming Robert E. Golz as inventor, filed 17 May 2013; and
2. U.S. patent application Ser. No. 13/726,662, entitled “A Cut Resistant Webbing System”, naming Robert E. Golz as inventor, filed 26 Dec. 2012.

### BACKGROUND

1. Field of Use

These teachings relate generally to a webbing or lanyards incorporating a Ultra Violet (UV) reactive dye and corresponding UV reference indicator

2. Description of Prior Art (Background)

The history of protecting workers at heights in the infant stages of fall protection was as basic as tying one end of a rope around the workers safety belt and the other end to an anchor point. Over the years the technology has become more sophisticated and formalized.

By the seventies most workers at heights were required by their employers to wear safety belts. However, many workers were negligent about securing the safety belts at a tie off point. The eighties required 100% tie off where the worker was required to use two lanyards attached to his safety belt. Used properly the worker would be secured with at least one lanyard 100% of the time. During the early nineties safety belts gave way to safety harnesses with a “D” ring on the back side of the harness to avoid serious back injuries and finally full body harnesses.

After years in development, the American National Committee on Standards for Fall Protection in 1992 issued the ANSI Z359.1 fall protection standard, later revised in 1999. This standard addressed the technological advances made by manufacturers of fall protection equipment. The Z359.1 is a voluntary compliance standard for the four elements of Personal Fall Arrest Systems. Included were the anchorages, body wear, connectors and deceleration devices.

The state of the art today for fall arrest systems is the use of Self Retracting Lifelines for fall restraint. The system is comprised of narrow webbing wound on to a reel that has a locking mechanism, similar to automotive locking retractor systems. The locking mechanism limits the fall distance to 24 inches, rather than the older technology which uses a personal energy absorber to limit the free fall distance to six feet.

Currently the American National Committee on Standards for Fall Protection is developing an expanded family of related standards. When completed the new standards will be composed of 18 separate standards to address every aspect of Fall Protection. Europe (EN 360:2002), Canada (CAN/CSA Z259.2.1-98 (R2011) and Australia (AS/NZS 1891.1; 2007) each have Fall Protection standards similar to the Z359 family of standards.

Each of the Z359 standards addresses a specific issue in Fall Protection. One of which is the Self Retracting Lifeline. This standard requires webbing used in the Self Retracting Lifelines meet a dynamic performance test for a retractable type fall arrestor in horizontal use. There is a clause in the proposed Z359.14 document, for a Self-Retracting Lanyard with Leading Edge Capability (SRL-LE). “A self retracting device suitable for applications where during use the device in not necessarily mounted or anchored overhead and may be at foot level and where the possible free fall is up to 5 ft. (1.5 m) that includes integral means to withstand impact loading of the line constituent with a sharp or abrasive edge during fall arrest and for controlling fall arrest forces on the user.

Webbing's that have been used for Self-Retracting Lifelines traditionally have been made with nylon or polyester fibers and having dimensions that were between ½″ wide up to 1½″ wide and thickness' of between 0.050″ and 0.100″. The purpose of using webbing with those dimensions was to keep the retractor compact and allow 6 feet of webbing to be coiled on the retractor reel.

When working at heights, it is standard industry practice (often guided by legal requirements of governmental agencies such as OSHA) to employ some sort of fall protection safety device. As noted earlier, for such devices to effectively protect users from dangerous falls, the device webbing must be of sufficient strength to bring a fall to a stop and to then hold the user above the ground. Thus, the structural integrity and/or strength of such devices may be critical in preventing serious bodily injury resulting from a fall. Currently, there is no known method to quickly, and objectively, determine if fall protection safety devices that have been used over some period of time still retain their original structural integrity/strength characteristics, or if they have been significantly degraded to the point where they should be retired from service. At best, some industries may simply apply a uniform rule (based mainly on estimation) that devices should be retired a certain number of years after manufacture.

However, this a very rough estimate, and does not take into account the specific use and/or environmental exposures of a particular device. For example, a device might have been stored away in inventory for many years, such that its actual useful lifespan might be many years more than the uniform rule would assume. This could lead to costly waste as useful devices are needlessly discarded. On the other hand, a particular device might be used in an environment where it is exposed to one or more harmful substances that could be detrimental to its structural integrity/strength. This could lead to a device being used beyond its actual useful lifespan (based on the application of a uniform rule).

Various attempts have been made to incorporate end of service life indicators into safety harnesses, belts, and lanyards. For example the patent application publication US20130056302 discloses various methods of combing UV sensing devices, known in the art, with webs and lanyards. For example, a UV sensing device in said publication may “turn color” when exposed to a sufficient amount of UV light. However, this approach fails to remove the subjective analysis of a color change. In other words, the publication fails to address how much of a color change is required for a determination that the webbing has been exposed to an excessive amount of UV radiation. The publication also fails to disclose or suggest how to address the person-to-person subjective color perception question in that the color perceived by person A is often not the exact same color perceived by person B.

In addition, the traditional webbing made of nylon and or polyester has not been shown to meet the Sharp edge testing requirements. Various methods of weaving and combinations of high performance fibers, e.g., high tenacity yarns such as, for example, Kevlar™, Spectra™, Dyneema™, Vectran™, and Twaron™, have been made to attempt meet the requirements of the Leading Edge Testing; but, have failed the standards requirements for sharp edge testing.

In other industrial applications medium, or heavy weight, industrial webbing is widely used, for instance, for truckload restraint systems, container tie downs, and other relatively high strength applications. Such webbings are typically woven in a double or multiple weave construction having an upper layer of fabric and a lower layer of fabric. The two or more layers are, of course, joined by many binders and further preferably include an inner layer of stuffer yarns.

Typically, medium or heavy weight industrial webbing is woven from synthetic multifilament yarn. While polypropylene is used when high strength is not necessary, high strength applications typically use nylon (polyamide) or polyester. Both nylon and polyester yarns have very high tenacity. Nylon yarn, however, because of its superior elongation actually requires more work to break. Polyester, because it has less elongation is beneficial since its elongation under load is less.

Various attempts have been made to strengthen industrial webbing. The Hammersia U.S. Pat. No. 4,856,837 utilizes vinyl coated yarns at the selvage edges of cargo slings. Ogata U.S. Pat. No. 4,600,626 shows seat belt webbing which utilizes a first weft thread having a low bending stiffness and a second weft thread having a high bending stiffness. The Pickering et al. U.S. Pat. No. 4,981,161 shows seat belt webbing having a soft, round edge. A combination of a multifilament yarn and a monofilament yarn is used as the filling or weft yarn. The Johnson U.S. Pat. No. 4,052,095 shows a web sling laminated with chloroprene rubber. The sides of the web are also covered with an elastomer. The Taki sling belt, U.S. Pat. No. 4,209,044, utilizes a sheath of polyamide filament yarns, and the face side of the belt is thicker than the back side. The Danzey U.S. Pat. No. 7,721,518 utilizes a multi-filamentary core which melts when the constructed webbing is subjected to heat; and, upon cooling, the filaments of the core wrapper are captured in a solidified matrix forming a comparatively harder material than if the core had not been melted. However, it will be appreciated that melting the core in this fashion may negatively change the filaments modulus of elasticity such that the modulus of elasticity is substantially different that the modulus of elasticity of the other synthetic fibers used in the webbing.

It is, therefore an outstanding object of the invention to provide webbing with exceptional cut resistant properties to the body of the webbing that can meet the Sharp Edge Testing requirements according to the aforementioned standards.

Another object of this invention is the provision for webbing for use in a Self-Retracting Lifeline which has excellent strength, toughness and most importantly a high degree of cut resistance.

It is a further object of the invention to provide a synthetic and metallic fiber system to increase the resistance of an article to damage by contact with sharp edge articles.

Another object of the invention is the provision of strengthening the longitudinal yarns used in the webbing.

It is a further objective of this invention to provide webbing wherein the remaining life expectancy of the webbing may be objectively determined by visual inspection.

With these and other objects in view, as will be apparent to those skilled in the art, the invention resides in the combination of parts set forth in the specification and covered in the claims appended hereto.

### BRIEF SUMMARY

The foregoing and other problems are overcome, and other advantages are realized, in accordance with the presently preferred embodiments of these teachings.

In carrying out the objectives of the present invention for a cut-resistant lanyard in a fall restraint retractor, the improved webbing system described herein is sufficient to meet and exceed the sharp edge cut resistance test. Wires, which may be any suitable type of wire, such as, for example, stainless steel wires, are woven into the elongated webbing intermittently to produce superior cut resistance in certain sections of the webbing. Other sections of the webbing, e.g., end sections, that may be affixed to the retractor reel itself, or attached to an anchor, may not need the superior cut resistance. For these applications the stainless steel wire may not weave as stuffer yarns; but, float aside from the synthetic yarns for a predetermined length.

In accordance with one embodiment of the present invention a cut resistant webbing component is provided. The cut resistant webbing component includes at least one wire strand core; and, at least one webbing yarn strand wrapped in a Z direction about the wire strand core. One or more second webbing yarn strands are wrapped in an S direction about the wire strand core. At least one of the Z-direction webbing yarn strands comprises at least one filament core, having a set core melting point, and is surrounded by a filament sheathing having a melting point different from the filament core melting point. The filament sheathing melting point may be lower, or higher, than the filament core melting point.

The invention is also directed towards cut resistant webbing having at least one upper ply and at least one lower ply coupled together with a binder yarn. The cut resistant webbing also includes a plurality of stuffer yarns disposed between the upper and lower plies. The stuffer yarns are comprised of at least one cut-resistant stuffer yarn and at least one stuffer wire. The stuffer wire may be any suitable wire such as stainless steel wire.

In accordance with another embodiment of the invention, cut resistant webbing formed from warp and weft yarns woven together is provided. The webbing includes face and back surfaces and at least one of the warp yarns is made to exhibit resistance to abrasion and cutting. The cut resistant warp yarn includes a plurality of individual filaments, wherein each individual filament comprises a core and an outer sheath. The melting point of the outer sheath is either higher or lower than the melting point of its core. In one embodiment the polyester core melts at around 489 degrees Fahrenheit. When the webbing is subjected to a heat treatment suitable to melt the sheathing, but not the core, the cut resistant warp yarn has at least as great a modulus of elasticity as the other wept and warp yarns not having multiple components. The cut resistant warp yarn is located intermediate the longitudinal edges of the webbing. In addition, the cut resistant webbing includes at least one stuffer wire, for example, a stainless steel wire, also located intermediate the longitudinal edges of the webbing. It will be understood that the stuffer wire provides for a superior cut and abrasion resistant webbing. For yarns having a core with a lower melting point than the sheathing, and subjected to a heat treatment that melts the core, the modulus of elasticity of the yarn may be significantly altered. Thus, the stuffer wire, in addition to providing for a superior cut and abrasion resistant webbing, also offsets the negative effects of a significantly altered modulus of elasticity.

The invention may also be directed towards a fall arresting personal safety device comprising: webbing of sufficient strength to effectively catch and hold a user falling from a height (for example, webbing able to support about 5000 pounds to about 7000 pounds); and one or more end of service life indicators operable to indicate exposure to one or more degrading conditions; wherein the one or more end of service life indicators change in visual appearance when exposed to sufficient concentration and duration of degrading condition to weaken the strength of the webbing; wherein the webbing comprises one of the following: nylon, polyester, Nomex, Kevlar, and combinations thereof; and wherein the webbing is formed into a safety harness, belt, or lanyard.

The invention is also directed towards webbing, or strands of webbing, dyed with a UV reactive dye which changes color and/or shading corresponding to UV exposure time; and, one or more corresponding non-UV sensitive reference indicators incorporated within the webbing. The one or more non UV sensitive reference indicators may be calibrated to tensile strengths such that the UV exposed dye may be visually matched with the reference indicator to objectively determine the webbing's remaining service life.

Another aspect of the invention is directed towards a UV reference indicator card wherein the card contains at least one UV reference indicator to be matched with the webbing system dyed with a UV reactive dye which changes color and/or shading corresponding to UV exposure. The UV references may be deposited on said card by any suitable means such as UV resistant inks or pigments.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view of a self-retracting lanyard incorporating reinforced webbing constructed in accordance with the present invention;

FIG. 2 is a perspective view of a reinforced cargo sling constructed in accordance with the present invention;

FIG. 3 is a sectional view of the sling shown in FIG. 2 or webbing shown in FIG. 1.

FIG. 4 is a plan view showing the cut-resistant wires and optional protective multi-component yarns located in a section of the webbing or sling shown in FIG. 1 and FIG. 2, respectively;

FIG. 5 is a transverse sectional view of the webbing or sling shown in FIG. 1 and FIG. 2, respectively, showing the cut-resistant wires and optional protective multi-component yarns;

FIG. 6A is a cross sectional view of a 1×19 wire strand used in accordance with the present invention shown in FIG. 1 and FIG. 2;

FIG. 6B is a cross sectional view of an optional 7×7 wire strand used in accordance with the present invention shown in FIG. 1 and FIG. 2;

FIG. 6C is a cross sectional view of an optional 7×19 wire strand used in accordance with the present invention shown in FIG. 1 and FIG. 2;

FIG. 7 is a cross-sectional view of an optional multi-component yarn used in accordance with the present invention shown in FIG. 1 and FIG. 2;

FIG. 8 is a pictorial view of an example length of webbing used in accordance with the present invention shown in FIG. 1 and FIG. 2;

FIG. 9 is a pictorial view showing the fabrication of a cut-resistant webbing component located in a section of the webbing or sling shown in FIG. 1 and FIG. 2, respectively;

FIG. 10 is a pictorial view showing the fabrication of an alternate embodiment of the cut-resistant webbing component located in a section of the webbing or sling shown in FIG. 1 and FIG. 2, respectively;

FIG. 11 is a pictorial view showing the fabrication of an alternate embodiment of the cut-resistant webbing component shown in FIG. 10;

FIG. 12, in accordance with the present invention, is a pictorial illustration of UV dyed webbing exposed to UV radiation over time and incorporating a reference indicator indicating when the UV webbing has lost 20% of its original tensile strength;

FIG. 13 is a graph of tensile strength loss over time of the web shown in FIG. 12; and

FIG. 14 is a pictorial illustration of a tensile strength loss reference card in accordance with the present invention.

### DETAILED DESCRIPTION

The following brief definition of terms shall apply throughout the application:

The term “outer” or “outside” refers to a direction away from a user, while the term “inner” or “inside” refers to a direction towards a user;

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

Disclosed embodiments may relate to fall protection safety devices having one or more end of service life indicators. Typically, the devices are fall arresting personal safety devices, such as safety harnesses, belts, lanyards, anchor slates, lifelines (which may be retractable), and the like, by way of nonexclusive example. Embodiments of such devices often might comprise webbing of sufficient structural integrity, strength, and/or tenacity to effectively protect against dangerous falls (by, for example, catching and/or holding the user in the event the user should fall from a height), along with one or more end of service life indicators to allow a user to quickly and easily inspect the safety of the device and to determine whether the device is still effective for safety purposes or whether there is sufficient risk of degradation that the device should be retired.

Persons of skill will be familiar with the types of webbing typically used for such devices. By way of example, the webbing typically may comprise nylon, polyester, NOMEX™, KEVLAR™, DYNEEMA™, and/or combinations thereof. In some embodiments, the webbing might typically include only a single type of structural support fiber/material. While other manufacturing methods may be appropriate, in embodiments such webbing may typically be woven. The dimensions (such as width and thickness of the webbing material), number of layers of material and stitching patterns and/or needle-punching used in creating the webbing might typically be selected so that the webbing has sufficient structural integrity/strength/tenacity for safety purposes (for example, to catch and support the weight of a user falling from a height). Oftentimes, the minimum strength requirement for webbing in such devices is legally set (based for example on OSHA requirements) and/or is set by industry standard or custom. So for example, the minimum legal standard in one industry might be 5,000 pounds (supportable by the webbing), while in another industry the standard or custom might be to have a minimum strength of 7,000 pounds (supportable by the webbing). Regardless, the webbing must possess sufficient strength to provide the safety restraint or fall arresting capabilities for embodiments of the device. In one embodiment, the webbing might be made of TREVIRA™ High Tenacity Spunbond Polyester with a minimum strength rating of 5,000, or alternatively 7,000 pounds.

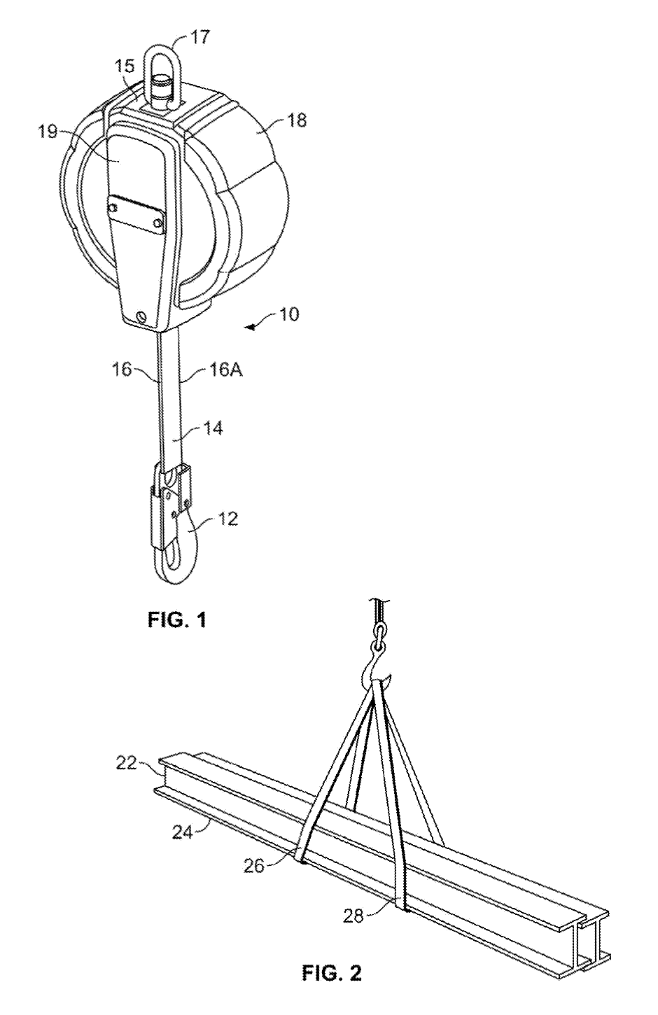

Referring now to FIG. 1, there is shown a typical, self-retracting lanyard (SRL) fully assembled. The improved braking mechanism with the pawl lockout element of the present invention is internal to that SRL unit and is not visible in that view. Such SRL's include a housing 18 about which is wrapped a cover 19, removable for easier servicing. Housing 18 has at its one end (directionally, at the top of FIG. 1) an anchor connector 17 for the SRL wearer/user to fasten the unit to an anchorage point. On this particular model, there is further shown a load indicator button 15 for quickly showing that this particular unit has not undergone a fall arrest and, as such, is safe to be used that day.

Below the housing 10 in FIG. 1A, there extends a webbing or lanyard 14 constructed in accordance with the present invention. At the lower end of webbing or lanyard 14, FIG. 1A shows the reinforced cut-resistant edging 16 of webbing or lanyard 14 constructed in accordance with the present invention that reinforces the connection of line 14 about snap-hook 12.

Referring also to FIG. 2, there is shown a perspective view of a reinforced cargo sling constructed in accordance with the present invention. FIG. 2 illustrates a typical sling application in which a pair of cargo webbing slings 26, 28 constructed in accordance with the present invention are used to hoist two I-beams 22 having flanges 24. Flanges 24 tend to be sharp-edged and can cut into the edges of typical slings, offering a severe application.

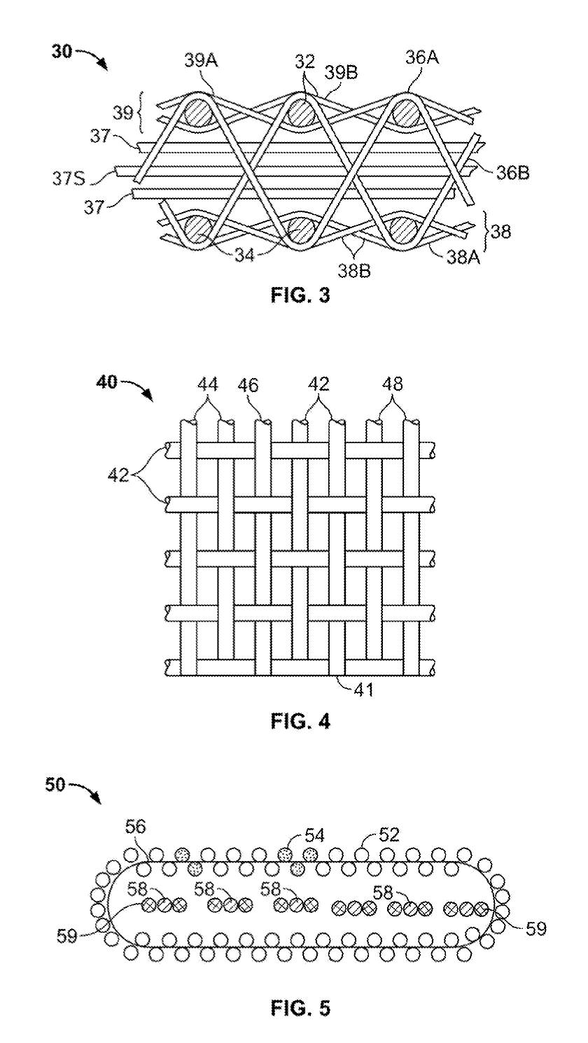

Referring also to FIG. 3, there is shown a sectional view of the slings 26, 28 shown in FIG. 2 or webbing 16 shown in FIG. 1. The main body 30 is surrounded by an upper ply 39 and a lower ply 38. It will be appreciated that while two plies are shown, any suitable number of plies may be used. The upper ply is formed with longitudinal warp yarns 39A, 39B and transverse or lateral weft yarns 32. The lower ply is formed with longitudinal warp yarns 38A, 38B and transverse or lateral weft yarns 34. The upper and lower plies are coupled via binder yarns 36A and 36B.

Also shown in FIG. 3 are stuffer yarns 37 and 37S interwoven with the binder yarns 36A and 36B between upper ply 39 and lower ply 38. As will be described herein stuffer yarns 37 may be any suitable stuffer yarn, such as, for example, Dyneema™, Spectra™, Vectran™, Twaron™, Nomex™, Kevlar™ and also yarns such as nylon or polyester.

Still referring to FIG. 3, the weft yarns 32, 34 and warp yarns 38A, 38B and 39A and 39B may also be any suitable yarn such Dyneema™ yarn. It will also be appreciated that the binder weave may be any suitable weave such as a double plain weave with two up two down binders. Other suitable weave types include two ply twill weaves, self-interlocking weaves, three ply weaves, or any combination thereof. It will also be appreciated that any suitable yarn may include wear indicator to gauge the amount of webbing wear.

Still referring to FIG. 3, it will also be appreciated that the ply warp yarns 38A, 38B, 39A, 39B and the stuffer yarns 37 may be any suitable bi-component or multi-component yarn combined with any suitable wire, such as, for example, stainless steel wire, as described herein in accordance with the present invention.

Also, shown in FIG. 3 are stuffer yarns 37S. As described herein stuffer yarns 37S may be any suitable wire such as a stainless steel wire strand or wire strand construction 1×19. It will be understood that any suitable wire strand constructions may be used, such as, for example, 7×7, or 7×19. It will be appreciated that the wire strands may be coated or galvanized. In addition, the wire strands may be wound in any suitable winding arrangement, such as, for example, regular lay, Lang lay, right lay, left lay, or alternate lay.

Referring also to FIG. 4, there is shown a plan view showing the cut-resistant wires and optional protective multi-component yarns located in a section 40 of the webbing 14 or sling 26, 28 shown in FIG. 1 and FIG. 2, respectively. Warp yarns may be any suitable combination of cut resistant yarns such as described herein with any suitable combination of suitable wire strands. For example warp yarn 42 may comprise a 1×19 stainless steel strand surrounded on both sides by cut resistant warp yarn 41 and cut resistant warp yarn 46. Likewise, warp yarn 48 may comprise any suitable cut resistant warp yarn or a bi-component or multi-component yarn discussed herein.

Referring also to FIG. 5, there is shown a transverse sectional view of the webbing or sling shown in FIG. 1 and FIG. 2, respectively, showing the cut-resistant wires and optional protective multi-component yarns. Weft yarns 56 and warp yarns 52 may be any suitable yarn such as, for example, Dyneema™, Spectra™, Vectran™, Twaron™, Nomex™, Kevlar™ and also yarns such as nylon or polyester. Stuffer yarns 59 may also be any suitable yarn, such as, for example, Dyneema™, Spectra™, Vectran™, Twaron™, Nomex™, Kevlar™ and also yarns such as nylon or polyester. Wire stuffer 58 may be any suitable wire such as a stainless steel wire strand construction 1×19. As noted earlier, it will be understood that any suitable wire strand constructions may be used, such as, for example, 7×7, or 7×19. It will be appreciated that the wire strands may be coated or galvanized. In addition, the wire strands may be wound in any suitable winding arrangement, such as, for example, regular lay, Lang lay, right lay, left lay, or alternate lay.

Still referring to FIG. 5, warp yarns 54, may be bi-component or multi-component warp yarns discussed herein.

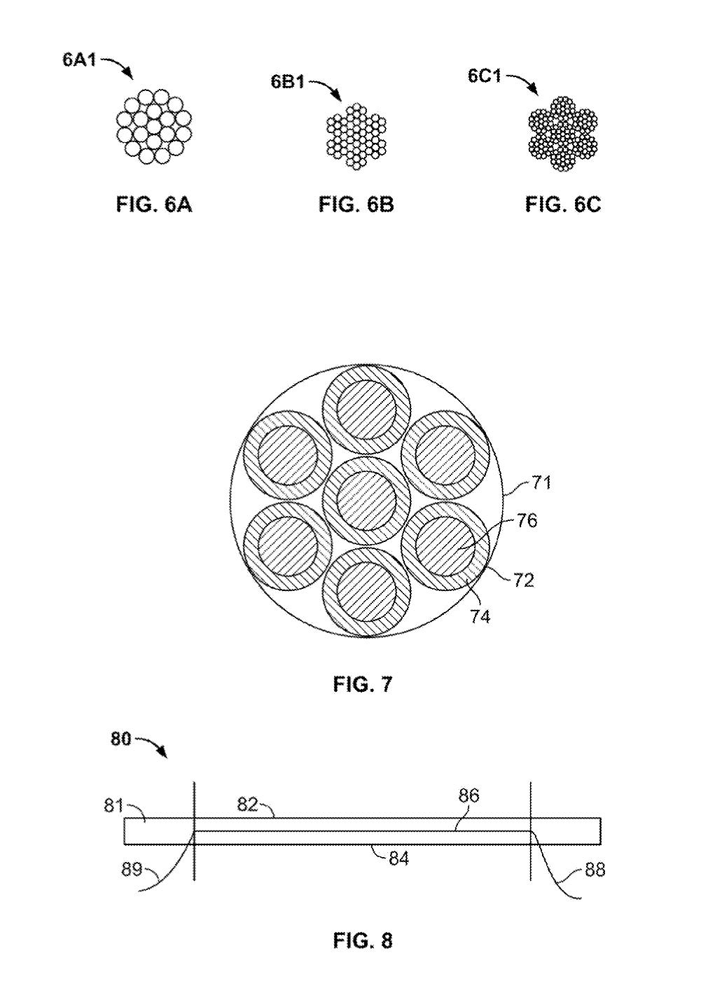

Referring also to FIG. 6A There is shown a cross sectional view of a 1×19 wire strand that may be used in accordance with the present invention shown in FIG. 1 and FIG. 2.

Referring also to FIG. 6B There is shown a cross sectional view of a 7×7 wire strand used optionally in accordance with the present invention shown in FIG. 1 and FIG. 2.

Referring also to FIG. 6C There is shown a cross sectional view of a 7×19 wire strand used optionally in accordance with the present invention shown in FIG. 1 and FIG. 2.

Referring also to FIG. 7 there is shown a cross-sectional view of an optional multi-component yarn used in accordance with the present invention shown in FIG. 1 and FIG. 2. Protective warp yarns 71 may be arranged anywhere in the lanyard webbing or cargo sling. Each protective yarn 71 consists of bi-component or multiple filaments 72, each having a core 76 and an outer sheath 74, the latter having a lower melting temperature than the core.

Specifically, each protective yarn 71 consists of multi-component or multiple filaments 72 which have a polyester core 76 which melts at a temperature of around 489 degrees F., and a sheath 74 that is formed of a polymer selected from the group consisting of nylon-6, polypropylene, or polyethylene, or any other fiber having a lower melting point than the core. It will be appreciated that any suitable core may be used, including, for example, polycyclohexanedimethanol terephthalate, poly trimethylene terephthalate, polybutylene terephthalate, PET glycol, copolyesters, aliphatic polyesters such as polylactic acid and polyhydroxyalkanoates and engineering polymers, such as, for example polyphenylene sulfide, acetal, ionomers, polyvinyl alcohol, polyetherimide, and thermoplastic polyurethanes. In addition, the bi-component cross section of protective warp yarn 71 may be any suitable cross section such as, for example, a pie wedge. Finally, it will be appreciated that the bi-component yarn 71 may be any suitable shape such as, for example, round, hollow pie wedge shape, trilobal, or segmented oval, to name a few.

Once the sling or webbing has been constructed in the manner described above, it is subjected to a temperature treatment that is sufficient to melt the sheath 74, but not the core 76. As a result of this melting or fusing operation, the molecular characteristics of yarn 71, and particularly sheath 74, are altered, resulting in an unexpectedly high resistance to abrasion. In addition, the melting operation results in some degree of fusion between adjacent protective yarns 71, resulting in a web-like structure that further enhances resistance to abrasion and cutting. The temperature treatment can be applied locally to edges (FIG. 1, item 16, 16A), or else the entire strap can be exposed to the heat source.

In a version of the present invention using wires and multi-component fiber, the multi-component fiber has a sheath of nylon-6 that is treated for approximately 4 minutes at about 435 degrees F. Another version of the invention uses a sheath of polypropylene that is treated for approximately 4 minutes at around 375 degrees F. A still further version of the invention uses a sheath of polyethylene which is treated for approximately 4 minutes at a temperature of around 300 degrees F. In all cases, the multi-component fiber has substantially the same modulus of elasticity as the synthetic fiber of the yarns of the main body, even after the fusing operation. In one embodiment, the end edges 16 and 16A shown in FIG. 1 are subjected, after the temperature treatment, to a cracking operation to increase their flexibility, while not decreasing the edge resistance to abrasion, and to cutting by sharp edges. In all of the above cases, the temperature of the applied heat is sufficient to melt or fuse the sheath 74, but not core 76.

Referring also to FIG. 8 there is shown a pictorial view of an example length of webbing 80 used in accordance with the present invention shown in FIG. 1 and FIG. 2. Webbing length 80 includes a top ply 82, a bottom ply 84 and at least one stainless steel stuffer wire 86. It will be appreciated that the stainless steel stuffer wire 86 is woven into the body 81 of the webbing 80 for a predetermined length defined by vertical boundary lines 89 and 88. Beyond these boundaries the stainless steel stuffer wire 86 at each end 88, 89, is allowed to “float”, or in other words, is not woven into the body 81 of webbing length 80.

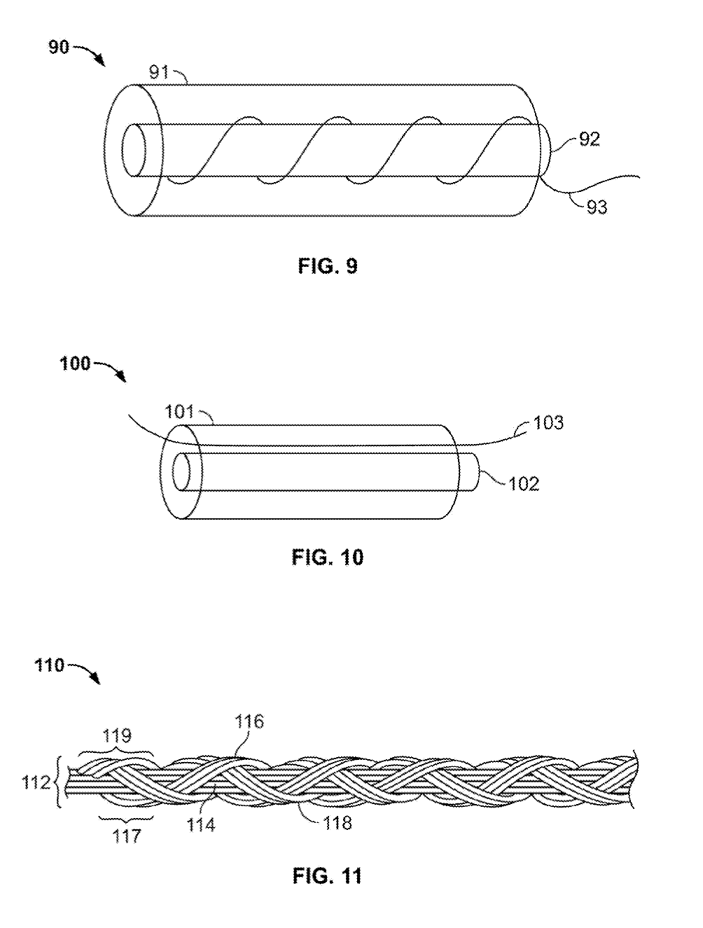

Referring also to FIG. 9 there is shown a pictorial view showing the fabrication of a cut-resistant webbing component 90 located in a section of the webbing or sling shown in FIG. 1 and FIG. 2, respectively. Webbing component 90 includes sheathing 91, component core 92, and wire 93. Wire 93 may be wrapped around, or woven with, component core 92 in either the S or Z direction. It will also be appreciated that any suitable number of wire strands or filaments may be used to wrap component core 92. Sheathing 91 may include any suitable number of webbing yarn strands or filaments, as described earlier, wrapped in either, or both, S or Z directions around the wire wrapped component core 92. It will be appreciated that component core 92 may be any suitable webbing material, as described earlier, or, such as, for example, bi or multi-component yarns having at least one filament core and a corresponding filament sheath (See FIG. 7). Further, sheathing 91 may also be composed of one or more bi-component, or multi-component yarn ends, each end having one or more filament cores, and each filament core surrounded by a filament sheathing having a higher, or lower, melting point than the filament core.

Still referring to FIG. 9, it will also be appreciated that wire 93 may be any suitable type of wire, such as, for example: stainless steel wire; copper wire, aluminum wire, or any suitable wire or wire alloy.

Referring also to FIG. 10 there is shown a pictorial view showing the fabrication of an alternate embodiment of the cut-resistant webbing component located in a section of the webbing or sling shown in FIG. 1 and FIG. 2, respectively. Webbing component 100 includes component sheathing 101, component core 102, and wire 103. Wire 103 may be adjacent to core 102. It will also be appreciated that any suitable number of wires may be adjacent to component core 102. Component sheathing 101 may include any suitable number of strands wrapped in either, or both, S or Z directions around the wire wrapped component core 102. Sheathing 101 may include any suitable number of webbing yarn strands or filaments, as described earlier, wrapped in either, or both, S or Z directions around the wire wrapped component core 102. Further, sheathing 101 may be composed of one or more bi-component, or multi-component yarn having one or more yarn cores surrounded by a yarn sheathing wherein the yarn sheathing may have a higher or lower melting point than the yarn core. In addition, component sheathing 101 may have a higher or lower melting point than the component core 102.

Still referring to FIG. 10, it will also be appreciated that wire 103 may be any suitable type of wire, such as, for example: stainless steel wire; copper wire, aluminum wire, or any suitable wire or wire alloy.

Referring also to FIG. 11 there is shown a pictorial view showing the fabrication of an embodiment of the cut-resistant webbing component 110 shown in FIG. 10. As discussed earlier, the cut-resistant composite yarn of the invention includes a core 114 that may include any suitable number and type of filaments 112, wrapped by at least one and optionally two strands, 116 and 118, to form sheathing 101. Each of the strands, 116 and 118, may comprise any suitable number and type of filaments 119 and 117. It will be appreciated that core 112 may be wrapped by strands 116 and 118, one each being applied in the S- and Z-directions, that is, one clockwise and the other counterclockwise.

Still referring to FIG. 11 it will be understood that core 114 may include a stainless steel strand, or a combination of stainless steel wire filaments with a combination of bi- or multi-component yarns having a yarn sheathing with a lower melting point than the core of the bi- or multi-component yarn; and, or, a combination of bi- or multi-component yarns having a yarn sheathing with a higher melting point than the core of the bi- or multi-component yarn.

Still referring to FIG. 11 it will be also be understood that strand 116 may include a stainless steel strand, or a combination of stainless steel wire filaments with a combination of bi- or multi-component yarns having a sheathing with a lower melting point than the core of the bi- or multi-component yarn; and, or, a combination of bi- or multi-component yarns having a sheathing with a higher melting point than the core of the bi- or multi-component yarn.

Still referring to FIG. 11 it will be also be understood that strand 118 may include a stainless steel strand, or a combination of stainless steel wire filaments with a combination of bi- or multi-component yarns having a sheathing with a lower melting point than the core of the bi- or multi-component yarn; and, or, a combination of bi- or multi-component yarns having a sheathing with a higher melting point than the core of the bi- or multi-component yarn.

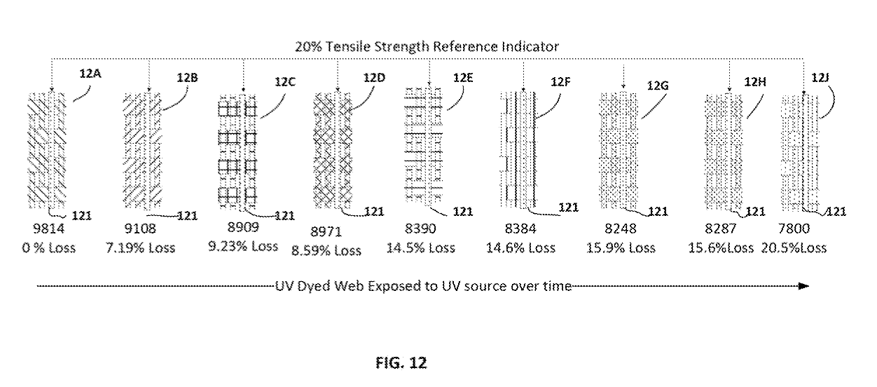

Referring also to FIG. 12 there is shown, in accordance with one embodiment of the present invention, a pictorial illustration of a section of UV dyed webbing exposed to UV radiation over time and incorporating a reference indicator yarn 121 indicating, for this example, when the webbing has lost 20% of its original tensile strength. It will also be appreciated that UV dye may be comprised of any suitable organic and/or inorganic dye.

It is understood that webbing 12A through 12J (12I is not used) represents one piece of webbing exposed to UV radiation over time. It will further be understood that for purposes of this description, it is desired that the webbing be replaced when the webbing has lost 20% of its original tensile strength. It will also be understood that the reference indicator yarn may be incorporated within any suitable position within the webbing. For example, the reference indicator 121 may be a 1″−2″ one ply plain weave webbing using yarns dyed to a red color that approximately matches the color shade exhibited by the UV indicator dyed yarns (12A-12J) after a predetermined number of UV exposure hours that correspond to a 20% tensile strength reduction of the webbing. The one ply webbing may be sewn onto the edges of the webbing with the UV indicator dyes, similar to a piping.

Webbing 12A is observed at time to, or in other words the webbing has not been exposed to UV radiation and there is 0% tensile strength loss. Thus, the 20% loss reference indicator 121 does not match the webbing 12A. It will be understood that the reference indicator 12A may be any suitable reference indicator such as a color. For example the reference indicator 12A may be a light shade of red corresponding to a 20% tensile strength loss. It will also be understood that the reference indicator 121 may be any suitable UV resistant reference indicator. The UV webbing dye may also be any initial suitable color and/or color shade. For example, at time to, the dyed webbing may be a color such as blue, indicating that the webbing has not been exposed to UV radiation for any appreciable amount of time.

Still referring to FIG. 12, there is illustrated webbing 12B. Webbing 12B is exposed to UV radiation for cumulative amount of time which deteriorates the webbing tensile strength by 7.19%. Again, the webbing pattern, or color, does not match the 20% loss reference indictor 121.

Likewise, webbing 12C illustrates a cumulative exposure to UV radiation resulting in 9.23% webbing tensile strength loss. Again, the webbing pattern, or color, does not yet match the 20% loss reference indictor 121.

FIG. 12 continues illustrating the tensile strength loss of the webbing due to cumulative UV exposure. At 12J the webbing matches the 20% reference indicator 121 which signifies that the UV dyed webbing has been exposed to UV radiation for a certain number of hours corresponding to a 20% loss of the webbing's original tensile strength.

It will be understood that any suitable number of reference indicator values may be employed within the webbing shown in FIG. 12. For example, there may be reference indicators corresponding to 5%, 10%, 15%, and/or 20%, or more. Using more than one reference indicator allows for visual determination of a UV dyed web's current tensile strength loss.

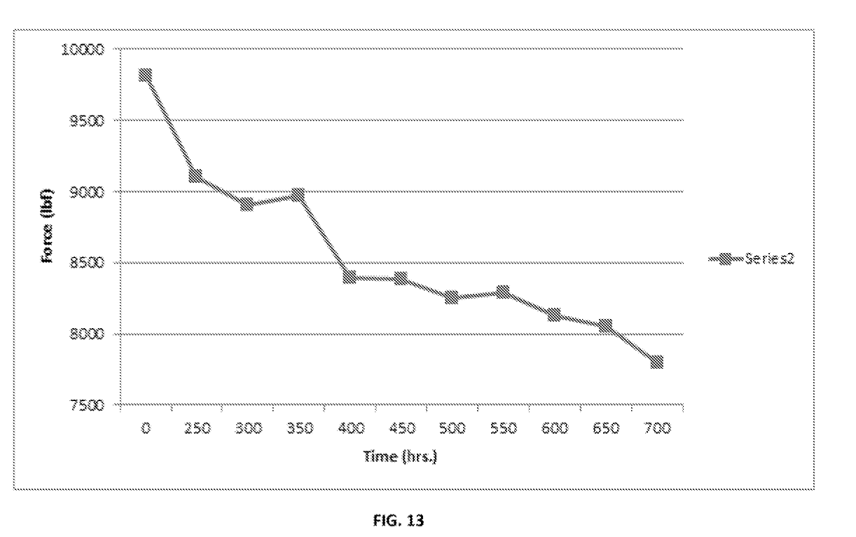

Referring also to FIG. 13 there is shown a graph of tensile strength loss over time of the UV dyed webbing shown in FIG. 12. At time to the webbing's tensile strength, for this example, is at its maximum of approximately 9,800 lbs. After UV exposure of approximately 700 hours, the UV dyed webbing tensile strength has decreased by approximately 20%, thus indicating, for this example, that the UV dyed webbing has reached its end of live service.

It is understood from FIG. 12 and FIG. 13 that the UV dye exposure reaction, e.g., changes in coloring or shading, is independent of the webbing material. In other words, the UV dyed webbing will change color and/or shade as a function of time and the UV dye chemical properties. However, the initial tensile strength and subsequent tensile strength loss of the webbing will be dependent upon the webbing material. Thus, for example, UV dyed webbing constructed from any suitable weft, warp, and stuffers yarns such as, for example, Dyneema™, Spectra™, Vectran™, Twaron™, Nomex™, Kevlar™ and also yarns such as nylon or polyester, may have different initial tensile strengths and subsequent tensile strength loss over time than similar webbing which also includes steel stuffer yards, and/or multi-component yarns described earlier. Thus, a 20% loss reference indicator may be a different color, or color shade, for webbing comprising only synthetic materials than a 20% loss indicator for webbing including muli-component and/or metal wires.

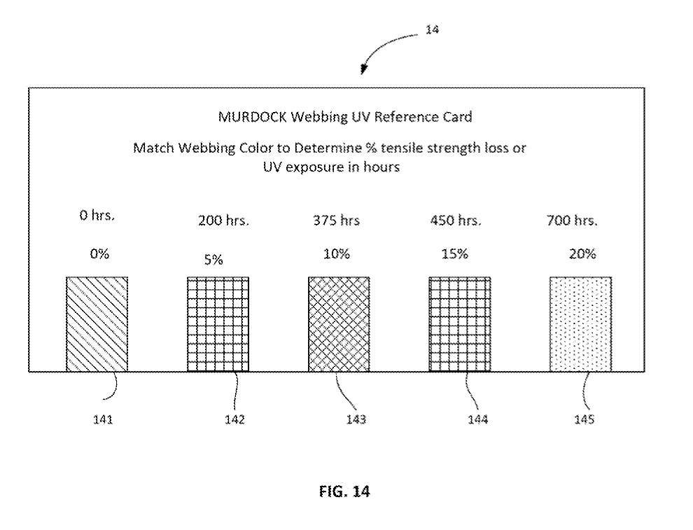

Referring also to FIG. 14 there is shown a pictorial illustration of a tensile strength loss reference card in accordance with the present invention. The loss reference card provides a ready reference for visually determining the current tensile strength loss of UV dyed webbing. For example, UV reference 141 corresponds to a 0% tensile strength loss. A user holding the card next to webbing, such as shown in FIG. 12, item 12A, can readily determine that the webbing has not been exposed to any appreciable UV radiation. Likewise, the user, holding the card near webbing illustrated in FIG. 12, item 12D can visually match the webbing's color or shade to reference 143 and thus determine that the webbing's current tensile strength loss is approximately 10%. Similarly, when the webbing shown in FIG. 12—item 12J matches reference 145, the user can determine that the webbing tensile strength loss is approximately 20%.

Still referring to FIG. 14, it will be understood that the UV reference indicators may be comprised of any suitable ink, paint, pigment, or combination thereof to reasonably represent the color or color shade of the UV dye exposed to a UV radiation source over time. It will also be appreciated that the UV reference indicators units could be stated in UV exposure hours which can then be correlated to a tensile strength loss table for the particular webbing under analysis. For example, UV loss indicator 143 could represent a cumulative UV exposure to a UV source of approximately 375 hours. Using the UV exposure of 375 hours a user can then determine the approximate tensile strength loss for differently constructed UV dyed webbings, e.g., webbing constructed with steel stuffer wires vs. webbing constructed without steel stuffer wires, from a predetermined look up table.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims. For example, the bi- or multi-component yarns having a sheathing with a higher or lower melting point than the core of the bi- or multi-component yarn may be subjected to a heating process before, or after, the cut-resistant webbing component (e.g., 110 shown in FIG. 10) is incorporated into a webbing (e.g., 14 shown in FIG. 1A.)

Likewise, the UV dyed webbing may be dyed by immersing webbing within a UV dye formula, removing excess dye and then drying the UV dyed webbing in a drying at approximately 400 degrees F for 10 minutes. However, various alternatives and modifications can be devised by those skilled in the art without departing from the invention. Accordingly, the present invention is intended to embrace all such alternatives, modifications and variances that fall within the scope of the appended claims. For example, UV sensitive webbing could be constructed partially, or entirely, with pre-dyed UV sensitive yarns.

In addition, the UV dyed webbing may be any suitable sized or shaped webbing, such as, for example, tubular webbings ranging in width from 2″ and up.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. An improved webbing system for visually determining remaining tensile strength, wherein the improved webbing system comprises:
webbing, wherein the webbing comprises:
a plurality of weft yarns;
a plurality of warp yarns;
at least one first yarn comprising a first appearance, wherein the first appearance color fades a first fixed decrement to a second appearance in response to Ultra Violet (UV) electromagnetic radiation exposure; and
a UV exposure reference indicator, wherein the appearance of the UV exposure reference indicator substantially matches the second appearance.

2. The improved webbing system as in claim 1, wherein the UV reference indicator comprises at least one second yarn.

3. The improved webbing system as in claim 2 wherein the at least one first yarn further comprises a UV exposure sensitive dye.

4. The improved webbing system as in claim 3 wherein the first and second appearances substantially represent a first and second tensile strength, respectively, associated with the webbing.

5. The improved webbing system as in claim 3 wherein the at least one first yarn comprises at least one yarn selected from the group consisting of the plurality of weft yarns and the plurality of warp yarns.

6. The improved webbing system as in claim 3 wherein the at least one second yarn comprises at least one yarn selected from the group consisting of the plurality of weft yarns and the plurality of warp yarns.

7. The improved webbing system as in claim 3 further comprising:
face and back surfaces derived from the plurality of weft yarns and the plurality of warp yarns, at least one of the warp yarns made to exhibit resistance to abrasion and cutting, the at least one warp yarn comprising:
a plurality of individual filaments, wherein each individual filament comprises:
a core and an outer sheath, the melting point of the outer sheath being lower than that of its core; and
the at least one warp yarn being located intermediate the longitudinal edges of the webbing.

8. The webbing as in claim 7 wherein the filaments each have a polyester core which melts at around 490 degrees F.

9. The webbing as in claim 7, wherein the webbing having been subjected to a heat treatment sufficient to melt the sheaths, but not the cores, comprises the at least one warp yarn having at least as great a modulus of elasticity as the other weft and warp yarns.

10. The webbing as in claim 7 wherein the at least one stuffer wire comprises at least one stainless steel stuffer wire, the at least one stuffer wire being located intermediate the longitudinal edges of the webbing.

11. An improved webbing system having integrated end of service life visual indicators, the improved webbing system comprising:
webbing, wherein the webbing comprises:
a plurality of weft yarns;
a plurality of warp yarns;
a plurality of stuffer yarns;
at least one first yarn comprising a first appearance, wherein the first appearance color fades a first fixed decrement to a second appearance in response to Ultra Violet (UV) electromagnetic radiation exposure, wherein the at least one first yarn further comprises a UV exposure sensitive dye; and
a UV exposure reference indicator, wherein the appearance of the UV exposure reference indicator substantially matches the second appearance.

12. The improved webbing system as in claim 11 wherein the first and second appearances substantially represent a first and second tensile strength, respectively, associated with the webbing.

13. The improved webbing system as in claim 11 wherein the at least one first yarn comprises at least one yarn selected from the group consisting of the plurality of weft yarns, the plurality of warp yarns, and the plurality of stuffer yarns.

14. The improved webbing system as in claim 11 further comprising:
face and back surfaces derived from the plurality of weft yarns and the plurality of warp yarns, at least one of the warp yarns made to exhibit resistance to abrasion and cutting, the at least one warp yarn comprising:
a plurality of individual filaments, wherein each individual filament comprises:
a core and an outer sheath, the melting point of the outer sheath being lower than that of its core; and
the at least one warp yarn being located intermediate the longitudinal edges of the webbing.

15. The webbing as in claim 14 wherein the filaments each have a polyester core which melts at around 490 degrees F.

16. The webbing as in claim 15, wherein the webbing having been subjected to a heat treatment sufficient to melt the sheaths, but not the cores, comprises the at least one warp yarn having at least as great a modulus of elasticity as the other weft and warp yarns.

17. The webbing as in claim 11 wherein at least one of the plurality of stuffer wire comprises at least one stainless steel stuffer wire, the at least one stuffer wire being located intermediate the longitudinal edges of the webbing.

18. A webbing system for visually determining remaining tensile strength, wherein the improved webbing system comprises:
webbing, wherein the webbing comprises:
a plurality of weft yarns;
a plurality of warp yarns;
a plurality of stuffer yarns;
at least one first yarn comprising a plurality of visual appearances, wherein each of the plurality of visual appearances corresponds, one-to-one, to a plurality of Ultra Violet (UV) electromagnetic radiation exposure durations, wherein the at least one first yarn comprises at least one yarn selected from the group consisting of the plurality of weft yarns, the plurality of warp yarns, and the plurality of stuffer yarns; and
at least one UV exposure reference indicator, wherein the appearance of the at least one UV exposure reference indicator substantially matches one the plurality of visual appearances.
